(19) United States
(12) Patent Application Publication
(10) Pub. No.: US 2020/0384535 A1
(43) Pub. Date: Dec. 10, 2020

(54) THREE-DIMENSIONAL SHAPING METHOD

(71) Applicant: CANON KABUSHIKI KAISHA, Tokyo (JP)

(72) Inventors: Hirokazu Usami, Yokohama-shi (JP); Soma Nakai, Machida-shi (JP); Takashi Yoshida, Tokyo (JP)

(21) Appl. No.: 16/891,320

(22) Filed: Jun. 3, 2020

(30) Foreign Application Priority Data
Jun. 10, 2019 (JP) 2019-108194
May 22, 2020 (JP) 2020-089385

(51) Int. Cl. B22F 3/105; B28B 1/00; B22F 1/00

(52) U.S. Cl. CPC B22F 3/1055; B28B 1/001; B33Y 10/00; B22F 2003/1057; B22F 2202/11; B22F 1/0059

(57) ABSTRACT

A three-dimensional shaping method for forming a shaped object using a powder made up of first particles, on a vertically movable shaping stage within a shaping container, the method includes a step of forming a powder layer made up of the first particles, on the shaping stage on which second particles that have a larger particle size than a particle size of each of the first particles are disposed along a gap between the shaping container and the shaping stage. R1 is an average particle size of the first particles, R2 is an average particle size of the second particles and d is a distance of the gap between the shaping container and the shaping stage. Expression (1) is satisfied:

R1≤d<R2 (1).

### BACKGROUND OF THE INVENTION

### Field of the Invention

The present invention relates to a three-dimensional shaping method of a shaped object.

### Description of the Related Art

Additive manufacturing methods that involve stacking a shaping material in accordance with slice data of a three-dimensional model, as an object to be shaped, have attracted attention as methods for shaping of three-dimensional shaped objects (three-dimensional objects).

Shaping using a resin material has been a mainstream method heretofore, but recently also devices for performing shaping using a shaping material other than resins, such as metals and ceramics, have become more prevalent. In mainstream devices, a powder layer is formed using a powder material, a shaping sectional layer is formed using a powder binding means, and these steps are repeated, to yield a shaped object.

Japanese Patent Application Publication No. 2015-38237 discloses a method for obtaining a shaped object, through repetition of a step in which a thin layer or a powder material is formed on a substrate, and high-temperature heating is performed locally thereafter by laser, to elicit sintering of the powder material. Japanese Patent Application Publication No. 2005-88432 discloses a method in which a powder layer is formed on vertically movable shaping stage, after which a linker is applied to the powder layer by an inkjet system, to thereby form a shaping sectional layer, whereupon the foregoing step being repeated to obtain a shaped object as a result. These shaping methods have a shared feature in forming a powder layer on a shaping stage using a powder material, but neither document describes a method for sealing the space between the shaping stage and the shaping container. For the purpose of preventing outflow of a powder material from between a edge of a shaping stage and the side wall of a shaping container, Japanese Patent Application Publication No. 2008-126668 discloses a method wherein a ring made up of a flexible material is disposed on a shaping stage, to thereby seal the space between the edge of the shaping stage and the side wall of the shaping container.

In the above method, however, a flexible material which is a sealing material deforms accompanying the operation of the shaping stage, upon raising/lowering of the shaping stage at the time of calibration referred to as origin setting and which is performed before shaping is initiated, or during shaping, or at the time of a termination operation once shaping is over. As a result the flexible material may be lodged between the edge of the shaping stage and the side wall of the shaping container, or the flexible material may break and the powder material may flow out, or the shaping stage may engage with the shaping container, and fail to move. A conceivable approach towards preventing such a phenomenon may involve reducing the distance between the edge of the shaping stage and the side wall of the shaping container as much as possible. In a case where the shaping stage is tilted, however, the shaping stage may engage with the shaping container, and be unable to move any further. Moreover in a case where the powder layer is heated, as in the method disclosed in Japanese Patent Application Publication No. 2015-38237, the flexible material may deteriorate, break or burn when a rubber is used as the flexible material, and the powder material may flow out as a result.

It is an object of the art disclosed herein, arrived at in the light of the above considerations, to provide a three-dimensional shaping method for effectively preventing outflow of a powder material, which is a shaping material, from between a shaping container and a shaping stage that rises/descends within the shaping container.

### SUMMARY OF THE INVENTION

According to an aspect, it is provided a three-dimensional shaping method for forming a shaped object using a powder made up of first particles, on a vertically movable shaping stage within a shaping container, the method including a step of:

forming a powder layer made up of the first particles, on the shaping stage on which second particles that have a larger particle size than a particle size of each of the first particles are disposed along a gap between the shaping container and the shaping stage,

wherein R1 being an average particle size of the first particles, R2 being an average particle size of the second particles and d being a distance of the gap between the shaping container and the shaping stage, satisfy Expression (1) below:

R1≤d<R2 (1).

Further features of the present invention will become apparent from the following description of exemplary embodiments with reference to the attached drawings.

### BRIEF DESCRIPTION OF THE DRAWINGS

FIG. 1 is a diagram illustrating schematically a shaping device according to an embodiment;

FIGS. 2A to 2H are a set of diagrams illustrating schematically a shaping method according to an embodiment;

FIGS. 3A to 3G are another set of diagrams illustrating schematically a shaping method according to an embodiment;

FIG. 4 is a diagram illustrating schematically the structure of a powder layer in a shaping method according to an embodiment;

FIG. 5 is a diagram illustrating schematically a device for carrying out a shaping method according to an embodiment;

FIG. 6 is a diagram illustrating schematically a gap between a shaping stage and a shaping container in an embodiment;

FIGS. 7A and 7B are a set of diagrams illustrating schematically particles of a powder layer intruding into a gap in an embodiment;

FIG. 8 is a diagram illustrating schematically a second particle disposed in a gap in a working example;

FIGS. 9A and 9B are a set of diagrams illustrating a particle size distribution of particles in a working example;

FIGS. 10A to 10C are a set of diagrams illustrating schematically a relationship between second particles and a gap in a variation;

FIGS. 11A and 11B is a set of diagrams illustrating schematically forces arising in second particles in a variation;

FIG. 12 is a diagram illustrating schematically a shaping device according to an embodiment;

FIG. 13 is a diagram illustrating an example of a gap portion between a stage and a shaping container in a variation; and

FIG. 14 is a diagram illustrating another example of a gap portion between a stage and a shaping container in a variation.

### DESCRIPTION OF THE EMBODIMENTS

Preferred embodiments of the art disclosed herein will be explained next with reference to accompanying drawings. However the dimensions, materials, shapes, relative arrangements and so forth of the constituent components described below are to be modified as appropriate depending on the configuration of the device to which the invention is applied and other various conditions. Accordingly, the scope of the invention is not meant to be limited to the disclosure that follows. Known features or known techniques in the relevant technical field can be adopted in configurations and steps that are not illustrated or described in particular. Recurring explanations may also be omitted.

The art disclosed herein relates to producing a three-dimensional shaped object using a particulate material (hereafter referred to as base particles). Accordingly, the method disclosed herein can be grasped as a three-dimensional shaping device such as an additive manufacturing (AM) system, a 3D printer, a rapid prototyping system or the like, as a control method of the three-dimensional shaping device, or as a three-dimensional shaping method.

Shaping Method

A three-dimensional shaping method according to the present embodiment includes (Step 1) to (Step 5) below:

(Step 1) step of calculating stress generated by the own weight of a shaped object, based on an inputted shaping model, and creating slice data using the calculation result as well as strength information stored in a storage unit;

(Step 2) step of forming a powder layer using a first powder containing first particles;

(Step 3) step of applying nanoparticles to a shaping portion within the formed powder layer;

(Step 4) step of sintering the powder layer, to fix first particles in the shaping portion to one another; and

(Step 5) step of removing first particles other than in the shaping portion.

By carrying out (Step 1) to (Step 5) it becomes possible to form a sheet-like (or plate-like) shaped object having the thickness of one powder layer. Then (Step 2) to (Step 3) are repeated, to thereby stack multiple powder layers, so that a three-dimensional shaped object can be formed as a result.

Three-Dimensional Shaping Device

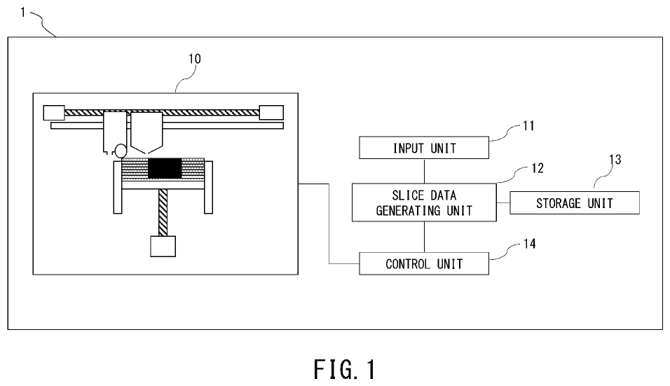

FIG. 1 is a diagram illustrating schematically a three-dimensional shaping device 1 according to an embodiment. The three-dimensional shaping device 1 has a shaping unit 10 that performs shaping, and an input unit 11 that receives input of data about a shaping model, as shaped object information. The three-dimensional shaping device 1 has a slice data generating unit 12 that analyzes the shaping model data, to create slice data of the shaping model. Further, the three-dimensional shaping device 1 has a storage unit 13 that stores various data used for performing the above steps, and a control unit 14 that controls the operation of the various units of the shaping device 1. The shaping unit 10, the input unit 11, the slice data generating unit 12, the storage unit 13 and the control unit 14 may be accommodated in a same housing within the device, or may be connected to each other, in the form of identical units. The input unit 11, the slice data generating unit 12, the storage unit 13 and the control unit 14 may be an integrated processing unit, or may be separate processing units.

The various steps executed by the three-dimensional shaping device 1 will be explained next.

(Step 1)

The input unit 11 of the three-dimensional shaping device 1 receives the input of information about the shaping model, prior to start of shaping of the shaping model. The input unit 11 may receive data denoting the shaping model. The slice data generating unit 12 generates slice data for forming the various layers for shaping of the shaping model, on the basis of three-dimensional shape data of the shaping model. To generate such slice data, for instance data created using 3D CAD, a 3D modeler, a 3D scanner or the like, for instance an STL (stereolithography) file or the like, can be preferably used as the three-dimensional shape data of the shaping model. The slice data is data obtained through slicing of the three-dimensional shape of the object to be shaped, in predetermined intervals (thickness), and encompasses information such as cross-sectional shape, layer thickness, material arrangement, and nanoparticle application amount. Given the influence on shaping precision that is exerted by the thickness of the layers that are formed in the shaping of the shaping model, the thickness of the layers may be determined in accordance with the requested shaping precision and in accordance with particle size of the particles that are used for shaping. Information about the amount of nanoparticles that are applied in step 3 may be given for instance in the form of grayscale density. In the above information, specifically, density from a maximum density to a minimum density (non-printing) is divided into 256 stages, and density and nanoparticle application amount are associated to each other.

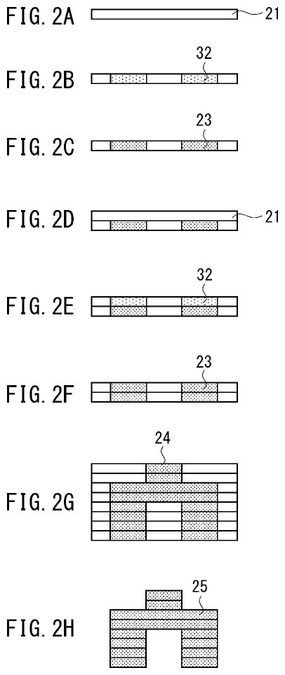

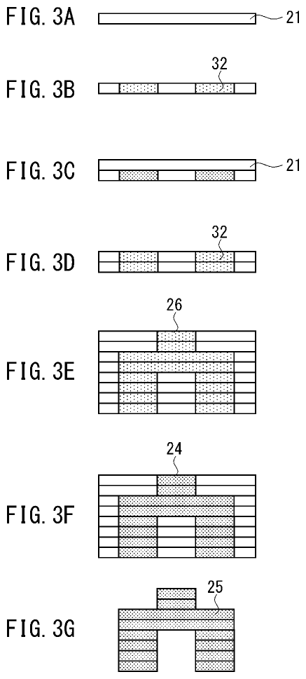

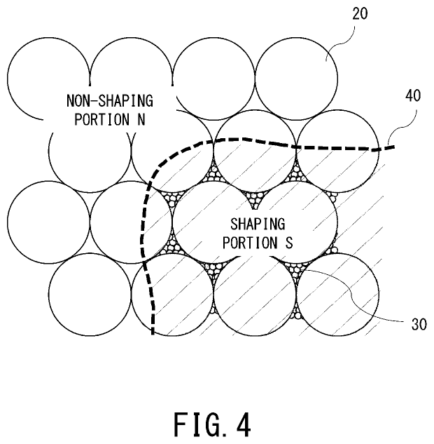

The various steps of the shaping method of the present embodiment will be explained next with reference to FIG. 2A to FIG. 2H, FIG. 3A to FIG. 3G, and FIG. 4. FIG. 2A to FIG. 2H and FIG. 3A to FIG. 3G illustrate schematically the flow of the shaping method of the present embodiment. FIG. 2A to FIG. 2H illustrate an example of the sequence of repeated execution of (Step 2) to (Step 4) a plurality of times, followed by execution of (Step 5), FIG. 3A to FIG. 3G illustrate an example of a sequence of execution of alternately repeating (Step 2) and (Step 3) a plurality of times, followed by execution of (Step 4) and (Step 5). FIG. 4 is an enlarged view diagram illustrating schematically the structure of a powder layer of first particles 20 formed in accordance with the shaping method of the present embodiment.

(Step 2) Step of Forming a Powder Layer Using a First Powder

In step 2 a powder layer 21 is formed using a first powder that contains first particles 20, on the basis of the slice data of the object to be shaped (FIG. 2A and FIG. 3A). Herein an aggregation of a plurality of particles will be referred to as “powder”, the layer resulting from evening out the powder to a predetermined thickness will be referred to as “powder layer”, and a pile resulting from overlaying a plurality of powder layers will be referred to as “stack”. Although the individual first particles 20 that make up the powder layer 21 at the stage of step 2 are not fixed to one another, the form of the powder layer 21 is however maintained by frictional forces that act among the particles.

For instance metal particles or ceramic particles can be used as the first particles 20 that form the powder layer 21. Specific examples of metals that can be used as the first particles 20 include copper, tin, lead, gold, silver, platinum, palladium, iridium, titanium, tantalum, iron and the like. A metal alloy such as a stainless steel alloy, a titanium alloy, a cobalt alloy, an aluminum alloy, a magnesium alloy, an iron alloy, a nickel alloy, a chromium alloy, a silicon alloy or a zirconium alloy can be used as the first particles 20. Also a material such as carbon steel, resulting from adding a non-metallic element such as carbon to a metal, may likewise be used herein as the first particles 20.

An oxide ceramic or a non-oxide ceramic may be used as the first particles 20. Examples of oxide ceramics include metal oxides such as silica, alumina, zirconia, titania, magnesia, cerium oxide, zinc oxide, tin oxide, uranium oxide, barium titanate, barium hexaferrite and mullite. Examples of non-oxide ceramics include silicon nitride, titanium nitride, aluminum nitride, silicon carbide, titanium carbide, tungsten carbide, boron carbide, titanium boride and the like. Further examples of non-oxide ceramics include zirconium boride, lanthanum boride, molybdenum silicide, iron silicide, barium silicide and the like. Further, the first particles 20 may be composite particles of a plurality of types of metals, or composite particles of a plurality of types of ceramics.

The average particle size of the first particles 20 is preferably set to a particle size that does not result aggregation, in order to form the powder layer 21 satisfactorily. Specifically, the volume-basis average particle size of the first particles 20 may be selected from the range of at least 1 μm and not more than 500 μm, and preferably may be selected from the range of at least 1 μm and not more than to 100 μm. Aggregation of the first particles 20 at the time of formation of the powder layer 21 can be suppressed, and a powder layer 21 of few defects can be formed, by virtue of the fact that the average particle size of the first particles 20 is 1 μm or larger. Further, the size of voids included in the powder layer 21 can be reduced, and the strength of the shaped object in the sintering step can be brought to a desired strength, by virtue of the fact that the average particle size of the first particles 20 is 100 μm or smaller. When the average particle size of the first particles 20 is larger than 500 μm, the surface of the shaped object may become rough, and it may be impossible to fabricate a high-precision shaped object.

The average particle size of the first particles 20 can be measured in accordance with a dry method, using a laser diffraction/scattering-type particle size distribution measuring device LA-950 (by Horiba, Ltd.). Measurement data is sampled so that transmittance lies in the range of 95 to 99%, with a data acquisition count set to 10000. The volume-basis average particle size of the first particles 20 can then be calculated from the measurement result obtained by the device.

The powder layer 21 can be formed using a material supply device provided with a container opened at the top, a vertically movable support set in the interior of the container, and a wiper, for instance as disclosed in Japanese Patent Application Publication No. H08-281807. Specifically, the top face of the support is controlled to a position lying below the upper edge of the container, by the thickness of one layer, and the material is supplied onto a flat plate by a material supply device, followed by planarization of the material by the wiper, as a result of which there can be formed one powder layer 21. Alternatively, the first powder can be supplied to a flat surface (stage or surface of the shaped object being produced), and the surface of the powder is evened out using a thickness regulating means (for instance a blade), so that a powder layer 21 of the desired thickness can be formed as a result. The formed powder layer 21 may be pressed by a pressing means (for example, a pressing roller or a pressing plate). The number of contact points between particles can increase, and formation of defects in the shaped object be rendered unlikelier, through pressing of the powder layer 21. In addition, the first particles 20 within the powder layer 21 are present more densely as a result of pressing; thus the movement of the first particles 20 i.e. the collapsing of the form of the powder layer 21 can be suppressed during subsequent processing (Step 3) and (Step 4), and a shaped object of high shape precision can be produced.

(Step 3) Step of Applying Nanoparticles to the Shaping Portion within the Powder Layer

In step 3, a particle powder having an average particle size in the range of at least 1 nm and not more than 500 nm is applied, as nanoparticles 30, to a shaping portion S within the powder layer 21, by a particle application device (FIG. 2B and FIG. 3B), on the basis of the slice data of the object to be shaped (three-dimensional model). The particle application device may rely on a method for applying a particle powder by airflow, or a method for applying a liquid 32 having a nanopowder 30 dispersed therein. A case where the particle application device applies the nanopowder 30 by the liquid 32, as described below, is advantageous in that the nanoparticles 30 are allowed to accumulate at the contact portions between first particles 20. Here, the “shaping portion S” denotes a region corresponding to the cross section of the object to be shaped (i.e. denotes a portion, within the powder layer 21, in which the powder is to be solidified and retrieved as a shaped object). A region other than the shaping portion S (i.e. a portion from which the powder is to be finally removed) will be referred to as a “non-shaping portion N”.

The nanoparticles 30 are particles capable of sintering/fusing at a lower temperature, and/or in a shorter time, than the first particles 20. Accordingly, in the case of heating a mixed powder of the first powder containing the first particles 20 and a second powder containing the nanoparticles 30, heating conditions can be set so that at least some of the first particles 20 of the first powder do not sinter (or do not fuse) with one another while the nanoparticles 30 of the second powder do sinter or fuse with one another. Heating conditions include herein heating temperature and heating time. In the case of heating of a mixed powder of the first powder and the second powder, the characteristics of the nanoparticles 30 can be selected so as to allow setting heating conditions such that the first particles 20 break easily together, whereas the nanoparticles 30 sinter with one another easily but without being crushed.

The term “sintering” refers herein to a treatment wherein a powder is heated in a state where the particles are in contact with one another at a temperature equal to or lower than the melting point thereof, whereupon the particles become fixed (bonded) to one another. The feature “do not sinter” encompasses a state in which particles are not fixed to one another, or a state in which the particles are fixed to one another by weak forces, such that the boundaries between particles fixed by weak forces can be discerned by electron microscopy.

In the shaping method of the present embodiment the nanoparticles 30 contained in the second powder are heated at a temperature at which the nanoparticles 30 sinter or fuse to one another, as a result of which the first particles 20 within the shaping portion S become fixed to one another, after which the first powder is removed from inside the non-shaping portion N.

Using a second powder containing nanoparticles 30 having an average particle size in the range of at least 1 nm and not more than 500 nm elicits herein the effect of sufficiently lowering the sintering or fusion start temperature of the second powder, as compared with the sintering start temperature of the first powder. That is because free energy in a state where the particles are in contact with each other increases through a reduction in particle size (particle size effect).

More preferably, the average particle size of the nanoparticles 30 contained in the second powder lies in the range of at least 1 nm and not more than 200 nm. Preferably, the average particle size of the nanoparticles 30 is 200 nm or smaller, since in that case not only does the sintering temperature but also the dispersibility of the nanoparticles 30 in a liquid 40 (also referred to as “nanoparticle dispersion”) increase, and uniformity at a time of application of the liquid 40 is enhanced.

The relationship between the average particle size R1 of the first particles 20 and the average particle size R3 of the nanoparticles 30 satisfies Expression (2) below:

R3<R1 (2).

It can be expected that an effect is elicited as a result in that the nanoparticles 30 can fill up gaps between the first particles 20, thus promoting fixing of the first particles 20 to one another by the nanoparticles 30.

The average particle size of the nanoparticles 30 may be set to a value that allows the nanoparticles 30 to get into gaps between the first particles 20, when the liquid 40 is applied.

For instance metal particles, ceramic particles or the like can be used as the nanoparticles 30. Specific examples of metals that can be used as the nanoparticles 30 include copper, tin, lead, gold, silver, platinum, palladium, iridium, titanium, tantalum, iron and the like. Also a metal alloy such as a stainless steel alloy, a titanium alloy, a cobalt alloy, an aluminum alloy, a magnesium alloy, an iron alloy, a nickel alloy, a chromium alloy, a silicon alloy or a zirconium alloy can be used as the nanoparticles 30. A material such as carbon steel, resulting from adding a nonmetallic element such as carbon to a metal, may likewise be used herein as the nanoparticles 30.

An oxide ceramic and a non-oxide ceramic may be used as the nanoparticles 30. Examples of oxide ceramics include metal oxides such as silica, alumina, zirconia, titania, magnesia, cerium oxide, zinc oxide, tin oxide, uranium oxide, barium titanate, barium hexaferrite and mullite. Examples of non-oxide ceramics include silicon nitride, titanium nitride, aluminum nitride, silicon carbide, titanium carbide, tungsten carbide, boron carbide, titanium boride and the like. Further examples of non-oxide ceramics include zirconium boride, lanthanum boride, molybdenum silicide, iron silicide, barium silicide and the like. Further, the nanoparticles 30 may be composite particles of a plurality of types of metals, or composite particles of a plurality of types of ceramics.

Preferably, the nanoparticles 30 contain at least one component identical to those of the first particles 20. By containing thus a same component, the surface of the nanoparticles 30 and the surface of the first particles 20 are readily bonded during sintering of the nanoparticles 30, and the first particles 20 can be fixed to one another more firmly. More preferably, the nanoparticles 30 are made up of a main component which is a component contained in the first particles 20. The final shaped object is a mixture of the first particles 20 and the nanoparticles 30. Therefore if the nanoparticles 30 are made up of a component (material) identical to those of the first particles 20, the amount of impurities within the shaped object is reduced, and the material of the shaped object is homogenized, which allows as a result enhancing the strength and the quality of the shaped object. In a case for instance where the first particles 20 are an iron-containing stainless steel alloy, then iron particles, iron oxide particles or the like can be suitably used as the nanoparticles 30.

A step of drying the liquid 40 applied to the powder layer 21 may be included between the step of applying the liquid 40 to the powder layer 21 and (Step 4) described below. The step of drying the liquid 40 is preferably carried out for each powder layer 21. The liquid 40 becomes gradually concentrated as drying of the liquid 40 progresses, and gathers, on account of the surface tension thereof, at grain boundaries between the first particles 20. The nanoparticles 30 in the liquid 40 gather selectively at the grain boundaries between the first particles 20, and aggregate with one other accompanying the movement of the liquid 40. As a result of this drying step the nanoparticles 30 accumulate at the grain boundaries of the first particles 20, which allows for efficient and firm fixing of the first particles 20 to one another at the time of the below-described sintering of the nanoparticles 30. The drying condition involved in drying of the liquid 40, such as optimal drying temperature and drying duration, may be selected for instance in accordance with the concentration of the liquid 40 and the application amount of liquid 40 on the powder layer 21.

A solvent may be added to the liquid 40, in order to increase the uniformity of the liquid 40. An aqueous solvent, an organic solvent or a mixed solvent of an aqueous solvent and an organic solvent can be used as a specific solvent. For instance pure water can be used as the aqueous solvent. For instance an alcohol such as methanol or ethanol, a ketone such as methyl ethyl ketone, acetone or acetyl acetone, or a hydrocarbon such as hexane or cyclohexane can be used herein. When a solvent is added to the liquid 40, the solvent evaporates at an appropriate rate during drying of the liquid 40; as a result, an effect can be elicited in that dispersion of the nanoparticles 30 is unlikelier to occur.

An additive can be added as appropriate to the liquid 40, in order to control the dispersibility of the nanoparticles 30 within the liquid 40. The liquid 40 may contain as needed a functional substance such as a pigment.

The liquid 40 may contain a linker for fixing particles in the powder layer 21. Existing substances can be used as the linker, but preferred herein is a substance that decomposes as a result of the below-described heating treatment in (Step 4). Through decomposition of the linker by heating, the linker can be removed in (Step 4) while the first particles 20 within the shaping portion S and/or nanoparticles 30 within the shaping portion S are fixed up to (Step 4); as a result, the linker is unlikely to become an impurity within the shaped object. For instance a resin material or a carbohydrate may be a specific instance of a linker. Preferably, the linker dissolves in the liquid 40.

The step of applying the linker and the step of applying the liquid 40 may be separate steps, or a step of applying a linker to the powder layer 21 may be provided between (Step 3) and (Step 4). In this case, the linker can be applied to the shaping portion S and/or the non-shaping portion N. By applying thus the linker, the first particles 20 can be fixed temporarily, and it can be expected that subsequent formation of the powder layer 21 can be carried out more easily.

As a method for applying the linker, a preferred method herein involves applying a liquid linker, resulting from dissolving a linker in a liquid, using a liquid application device. For instance a resin solution resulting from dissolving a resin material in a solvent, or a solution resulting from dissolving a water-soluble substance in water, can be used as the liquid linker.

When the liquid 40 having the nanoparticles 30 dispersed therein and the liquid containing the linker are separately applied to the powder layer 21, an effect can be expected to be elicited whereby the respective liquid application devices can be optimized independently in accordance with the liquid to be applied, and the durability of the application device can be increased.

The linker applied to the powder layer 21 in (Step 3) contributes to fixing of the first particles 20 and/or nanoparticles 30 within the shaping portion S, the linker being then decomposed and removed as a result of the heating treatment in (Step 4). Therefore, the shape of the shaped object throughout (Step 3) is maintained by the linker applied within the shaping portion S, in (Step 4), the linker is decomposed by heat, and the decomposition product is removed by moving through the gaps between the first particles 20. As a result the linker is less prone to remain as an impurity in the shaped object, and the first particles 20 within the non-shaping portion N are easy to remove. Preferably, the type and amount of the linker are determined so that there is no residual linker.

Any device may be used as the liquid application device used for applying the liquid 40 or a liquid containing the linker, so long as the device is capable of applying a liquid or linker-containing liquid in a desired amount at a desired position of the powder layer 21. From the viewpoint of enabling precise control of the liquid amount and arrangement position, an inkjet device that applies a liquid to the powder layer in accordance with an inkjet scheme can be preferably used as the liquid application device. In a case where the liquid 40 being a dispersion of the nanoparticles 30 and a liquid that contains a linker are applied separately, an inkjet device may be used that has heads equipped with respective nozzles for discharge of the respective liquids. A configuration wherein application of the liquid 40 and application of the linker-containing liquid to the shaping portion S are carried out all at a time may be adopted in the above inkjet device.

In a case where respective liquids are discharged by the inkjet device it is necessary to bring the viscosity of the liquid 40 to an appropriate value, preferably 50 cP or less, more preferably 20 cP or less. Also, the viscosity of the liquid 40 must be brought to an appropriate value in order to allow the liquid 40 to diffuse quickly between the first particles 20, and in order to cause the liquid 40 to aggregate between the first particles 20 during drying. A value of viscosity of 20 cP or less can be expected herein to elicit the effect of making discharge of the liquid 40 easier to control.

The volume concentration of the nanoparticles 30 in the liquid 40 is preferably a high concentration, within the viscosity range of the liquid 40, in order to enhance strength by increasing the volume density of the shaped object. However, the volume concentration of the liquid 40 is preferably low, from the viewpoint of readily accumulating nanoparticles 30 in the vicinity of contact points between the first particles 20, in the process of drying the liquid 40. Such being the case, the volume concentration of the liquid 40 is preferably 50 vol % or less, and more preferably 30 vol % or less. By virtue of the fact that the volume concentration is 50 vol % or less, an effect can be expected to be achieved in that the nanoparticles 30 accumulate readily between first particles 20 in the process of drying the liquid 40, and the first particles 20 can be fixed yet more efficiently.

Application of the liquid 40 can be performed divisionally over a plurality of times, to thereby enable controlling the concentration of the nanoparticles 30 in the powder layer 21. In this case a drying treatment is performed each time that the liquid 40 is applied, since in that case movement of the liquid 40 in the non-shaping portion N can be prevented yet more effectively.

(Step 4) Step of Sintering or Fusing the Second Powder, to Fix First Particles to One Another in the Shaping Portion

In the present step the powder layer 21 is heated under conditions such that the second powder sinters or fuses, to thereby elicit fixing of the first particles 20 within the shaping portion S to one another through sintering or fusing of the nanoparticles 30 (FIG. 2C, FIG. 2F and FIG. 3F).

The reference symbol 23 in FIG. 2C and FIG. 2F denotes a region in which the particles become fixed to one another, in the present step. In the series of shaping processes illustrated in FIG. 2A to FIG. 2H, (Step 2) to (Step 4), i.e. FIG. 2D to FIG. 2F are repeated, to stack powder layers while the particles within the shaping portion S are fixed, so that a stack 24 having a shaped object in the interior thereof is formed as a result. In the series of shaping processes illustrated in FIG. 3A to FIG. 3G, (Step 2) and (Step 3), i.e. FIG. 3C to FIG. 3D are repeated, to stack powder layers having nanoparticles 30 applied within the shaping portion S, after which the multiple powder layers that make up a stack 26 are heated collectively. Also in this shaping process there is formed the stack 24 having the shaped object in the interior thereof, similarly to FIG. 2G. A step of pressing the stack 26 may be provided that precedes heating of the stack 26. An effect can be expected to be elicited, through pressing of the stack 26, in that the number of contact points between the first particles 20 increases, and binding of the particles at the time of heating progresses efficiently. The melting point of the nanoparticles 30 is lower than the melting point of the first particles 20 and the melting point of the below-described second particles 50. Through setting of the heating condition in the present step at or above the sintering temperature or at or above the melting point of the nanoparticles 30, and below the melting point of the first particles 20 and below the melting point of the second particles 50, it becomes possible to link and fix the first particles 20 to one another only at the portion at which the nanoparticles 30 are applied.

The atmosphere at the time of heating can be established arbitrarily, depending on type of the materials involved. In the case of metals, for instance, it is preferable to perform heating in an inert gas of Ar, N₂ or the like, or an atmosphere of low oxygen content, for instance a hydrogen gas atmosphere or vacuum atmosphere, since in that case it is possible to suppress oxidation of the metal during sintering.

In the step of (Step 4), an organic component and a resin component are removed by heat in a state where the first particles 20 are present around the foregoing, and hence a residual carbon component within the shaped object can be reduced, while maintaining the shape of the shaped object. Also in a case where in particular the shaped object exhibits a mixture of shapes of dissimilar thickness, it becomes possible to remove the organic component and the resin component within the shaped object, and hence an effect can be expected to be elicited in that the degree of freedom of the shape of the shaped object is increased as a result.

(Step 5) Step of Removing First Particles Other than in the Shaping Portion

In the present step, powder other than in the shaping portion S is removed from the stack 24 obtained in (Step 4), to yield a shaped object 25 (FIG. 2F and FIG. 3G). Any method, including known methods, can be resorted to as the method for removing unnecessary powder from the stack 24. For instance a physical removal method such as washing, air blowing, suction, vibration or brushing can be adopted herein.

As described above, the second powder has a lower sintering or fusion start temperature than the first powder, on account of the particle size effect. By selecting therefore an appropriate sintering temperature and sintering time, the first particles 20 included in the powder to be removed do not become fixed, or even if so, are however fixed more weakly than in the shaping portion S, and thus unnecessary powder can be removed easily. The powder removed in the present step can be recovered and be re-used as shaping material.

Herein (Step 2) to (Step 5) described above merely illustrate basic steps in the shaping method of the present embodiment, and the scope of application of the art disclosed herein is not limited to the matter described above. The specific details of the processes in the above-described steps can be modified as appropriate, and steps other than the above-described ones can be added.

For instance, (Step 5) may be followed by a step of heating the shaped object 25 at a higher temperature than the heating temperature in (Step 4). By performing such an additional heating treatment it becomes possible to further increase the density of the particles that make up the shaped object 25. In this additional step the shaped object 25 may be heated in accordance with conditions (heating temperature, heating time and so forth) at which the first particles 20 become sintered. Sintering of the first particles 20 to one another results in enhanced characteristics of the shaped object 25, and allows further increasing the strength of the shaped object 25.

In (Step 1) to (Step 5) above the first particles 20 are fixed to one another using the nanoparticles 30. However, instead of using the nanoparticles 30 it is also possible to apply for instance a liquid epoxy resin, an ultraviolet-curable resin or a resin solution resulting from dissolving a resin in an organic solvent, and to solidify the resin component, to thereby fix the first particles 20 to one another. Alternatively, the first particles 20 in the powder layer 21 may be heated directly by laser or the like, to thereby fuse the first particles 20 and thus fix the first particles 20 to one another.

Particle Production Method

The first particles 20 and the nanoparticles 30 may be produced in accordance with any methods, including known methods. For instance gas atomization or water atomization is preferably used as the method for producing metal particles, as the first particles 20 and/or nanoparticles 30, from the viewpoint of allowing obtaining substantially spherical particles. A wet type production method such as a sol-gel method is preferably used as the method for producing ceramic particles, as the first particles 20 and/or nanoparticles 30, from the viewpoint of allowing obtaining substantially spherical particles. Also a dry production method that involves cooling and solidifying a metal oxide having been liquefied in high-temperature air is preferably used as a ceramic particle production method.

### Working Example 1

A concrete working example of the production method of the above embodiment will be explained next.

Three-Dimensional Shaping Device

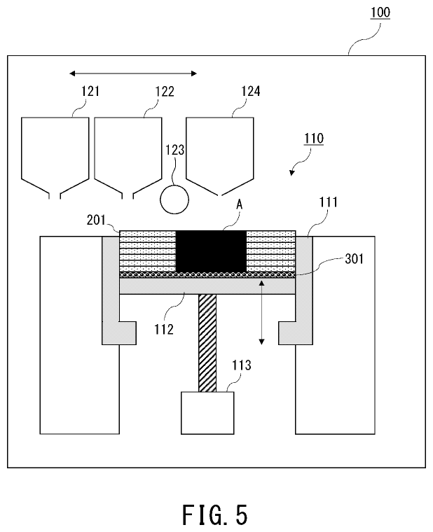

The shaping method according to the present working example can be realized using a three-dimensional shaping device 100 such as that illustrated in for instance FIG. 5. The three-dimensional shaping device 100 is applied with a shaping container 110 and a first particle supply device 121, a second particle supply device 122, a powder planarization roller 123, and a coating device 124 that applies a nanoparticle dispersion. The shaping container 110 is made up of a side wall 111 and a shaping stage 112 that can be raised/lowered by a transport motor 113. The shaping container 110 may be attachable/detachable to/from the three-dimensional shaping device 100.

Shaping Container

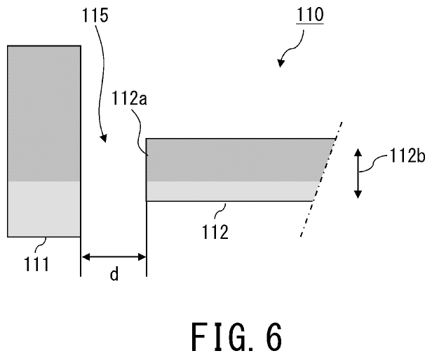

As illustrated in FIG. 6, the shaping stage 112 rises/descends in the direction denoted by arrow 112b. A gap 115 of a distance d is provided between the edge 112a of the shaping stage 112 and the side wall 111, in order to raise/lower the shaping stage 112. The distance d is preferably at least 50 μm and not more than 1 mm, more preferably at least 100 μm and not more than 500 μm. When the distance d is smaller than 50 μm, the shaping stage 112 and the side wall 111 come in contact with each other just on account of slight tilting of the shaping stage 112, and the shaping stage 112 may be incapable of rising/descending. When the distance d is by contrast greater than 1 mm, the shaping stage 112 may be acted upon by a vertically downward force from the powder planarization roller 123 at the time where particles on the shaping stage 112 are evened out by the powder planarization roller 123. As a result, stacking of powder layers 201 on the shaping stage 112 may fail to be carried out stably.

Arrangement of Second Particles

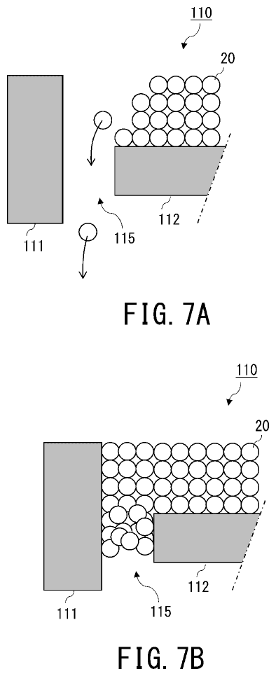

In a case where the particle size of the first particles 20 is smaller than the distance d of the above-described gap 115, the first particles 20 flow outward of the shaping container 110 through the gap 115, as illustrated in FIG. 7A, and defects may occur in the powder layer on the shaping stage 112. Also a case where the particle size of the first particles 20 is smaller than the distance d of the above-described gap 115, the first particles 20 may clog the gap 115 as illustrated in FIG. 7B, and in some instances the shaping stage 112 may be incapable of rising/descending.

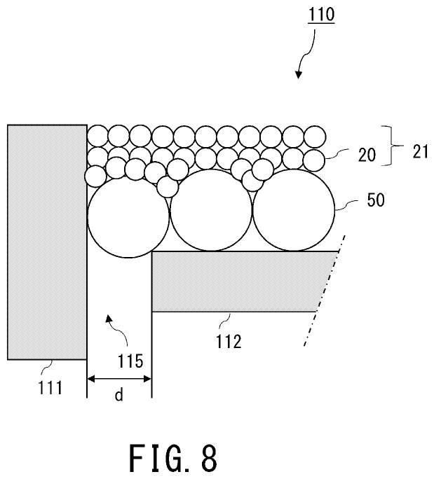

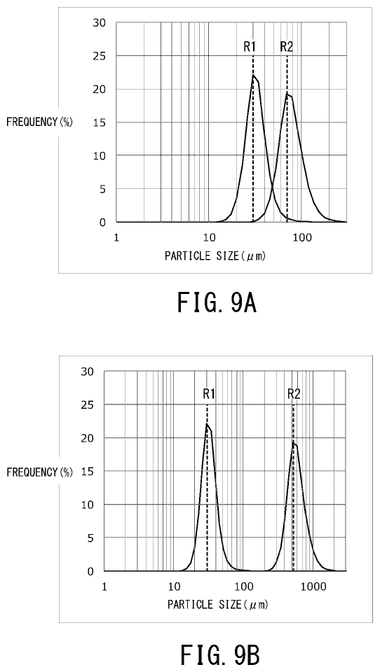

In the stack of the powder layers on the shaping stage 112 of the present working example, therefore, the second particles 50 having a larger particle size than the particle size of the first particles 20 are disposed in the gap 115, in order to prevent the first particles 20 from intruding into the gap 115. Specifically, second particles 50 having a particle size relatively larger than that of the first particles 20, and larger than the distance d of the gap 115, are disposed prior to formation of a first powder layer 21 containing the first particles 20, as illustrated in FIG. 8. The feature to the effect that the second particles 50 are relatively larger than the first particles 20 signifies herein that, as illustrated in FIG. 9, an average particle size R2 of the second particles 50 is larger than an average particle size R1 of the first particles 20, in a comparison between average particle sizes of the foregoing (“particle sizes” in the figure) based on particle volume. Preferably, a particle size distribution of the first particles 20 and a particle size distribution of the second particles 50 are sufficiently spaced from each other so as not to overlap, as illustrated in FIG. 9B, from the viewpoint of classifying and re-using the first particles 20 and the second particles 50 of the non-shaping portion N after shaping is over.

A relationship between the distance d of the gap 115 and the average particle size R2 of the second particles 50 will be explained next. In the explanation that follows, the relationship between the average particle size R1 of the first particles 20 and the distance d of the gap 115 satisfies Expression (3) below. In the explanation below, moreover, the average particle size of the particles will be referred to as particle size.

R1≤d (3)

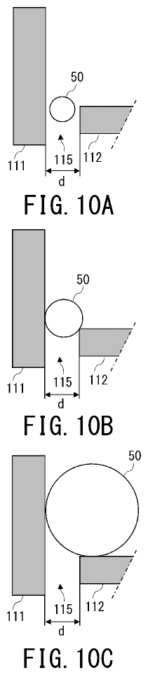

FIG. 10A illustrates an instance where the relationship between the distance d of the gap 115 and the particle size R2 of the second particles 50 satisfies Expression (4) below:

d≥R2 (4).

In the case illustrated in FIG. 10A, the second particles 50 can pass through the gap 115, and hence intrusion of the first particles 20 into the gap 115 cannot be prevented by the second particles 50.

Next, FIG. 10B illustrates an instance where the relationship between the distance d of the gap 115 and the particle size R2 of the second particles 50 satisfies Expression (5) and Expression (6) below:

d<R2 (5).

R2/2<d (6)

In the case illustrated in FIG. 10B, the second particles 50 get into the gap 115, but cannot pass therethrough, and remain on the shaping stage 112, which allows thus plugging the gap 115. Intrusion of the first particles 20 into the gap 115 can be prevented as a result by the second particles 50.

Next, FIG. 10C illustrates an instance where the relationship between the distance d of the gap 115 and the particle size R2 of the second particles 50 satisfies Expression (7) below:

d≤R2/2 (7).

In the case illustrated in FIG. 10C the second particles 50 cannot get into the gap 115. It is considered that, as a result, the likelihood that the rising/descent of the shaping stage 112 may be hindered by the second particles 50 is lower than in the case of FIG. 10B, and a smoother rising/descent of the shaping stage 112 can be realized as a result.

As an example, in the present embodiment the distance d of the gap 115 is set to 250 μm, and any of the below-described high-purity alumina balls (by AS ONE Corporation) may be used as the second particles 50.
Particle size 200 μm (AL9-0.2)
Particle size 300 μm (AL9-0.3)
Particle size 500 μm (AL9-0.5)

The material of the second particles 50 is preferably a material heat-resistant enough so as not to soften or sinter in the first sintering step described below. When using a flexible material such as a resin or rubber as the second particles 50, these deform on account of frictional forces between the side wall 111 of the shaping container 110 and the second particles 50 when the shaping stage 112 rises/descends. As a result, the second particles 50 become lodged between the side wall 111 of the shaping container 110 and the shaping stage 112, and the shaping stage 112 may be incapable of rising/descending. A ceramic is thus suitable as the second particles 50 from the above standpoint.

First Particles

A gas atomized powder of SUS 316L (LPW-316-AAAV, average particle size 30 μm, by LPW Technology Ltd.) was used as the first particles 20 in the present embodiment.

Nanoparticle Dispersion

Herein 5.0 g of iron nanoparticles (by Sigma-Aldrich Corporation; average particle size 25 nm) were dispersed in 45.0 g of ethanol (by Kishida Chemical Co., Ltd.), to yield a nanoparticle dispersion. The volume concentration of iron nanoparticles in the obtained nanoparticle dispersion was 1.1 vol %. The viscosity of a solution A was 1.2 cP.

Shaped Object Creation Step

In the three-dimensional shaping device 100 illustrated in FIG. 5 the second particles 50 are supplied from the second particle supply device 122 to the shaping stage 112, and are evened out uniformly by the powder planarization roller 123, to form a second particle layer 301. Thereafter, the shaping stage 112 of the three-dimensional shaping device 100 is lowered by one layer, and the first particles 20 are supplied from the first particle supply device 121 onto the second particle layer 301 on the shaping stage 112. The supplied first particles 20 are then evened out uniformly by the powder planarization roller 123 of the three-dimensional shaping device 100, to thereby form a powder layer 201. The nanoparticle dispersion is applied to the shaping portion of the powder layer 201, by the coating device 124 of the three-dimensional shaping device 100. After application of the nanoparticle dispersion, the shaping stage 112 of the three-dimensional shaping device 100 is lowered by one layer, a powder layer 201 is formed again, and thereafter the above-described step is repeated, to form a stack as a result.

Results of an evaluation of stack stability according to particle size of the second particles 50 are set out in the table below. The meaning of the reference symbols in the table below pertaining to lodging (clogging) of the second particles 50 in the gap 115 are as follows.

Good (◯): no clogging occurs; the shaping stage 112 can rise/descend stably.

Fair (Δ): no clogging occurs, but the vertical motion of the shaping stage 112 may in some instances be unstable

Poor (x): clogging may occur, the shaping stage 112 may fail to rise/descend.

The reference symbols in the table below, pertaining to outflow of the powder from the powder layer 201 to the exterior of the shaping container 110, have the following meanings.

Good (◯): powder does not flow out; a shaping sectional layer can be formed stably in the powder layer 201

Poor (x): powder flows out, the shaping sectional layer may fail to be formed on the powder layer 201

TABLE 1

| | | PARTICLE | PARTICLE | | OUTFLOW |
|---|---|---|---|---|---|
| | GAP | SIZE R1 | SIZE R2 | | FROM |
| | DISTANCE | OF FIRST | OF SECOND | CLOGGING | SHAPING |
| CONDITIONS | d | PARTICLES | PARTICLES | AT GAP | CONTAINER |
| CONDITION 1 | 250 μm | 30 μm | 200 μm | x | x |
| CONDITION 2 | 250 μm | 30 μm | 300 μm | Δ | ∘ |
| CONDITION 3 | 250 μm | 30 μm | 500 μm | ∘ | ∘ |

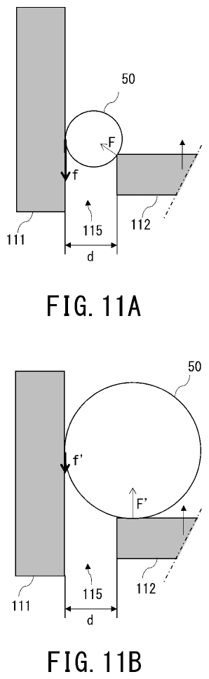

Condition 2 and Condition 3 in Table 1 are explained below. FIG. 11A and FIG. 11B illustrate forces generated by the second particles 50 when the shaping stage 112 rises under Condition 2 and under Condition 3, respectively.

As illustrated in FIG. 11A, in a case where the relationship between the distance d of the gap 115 and the particle size R2 of the second particles 50 satisfies Expression (5) and Expression (6) above, part of the second particles 50 get into the gap 115. Accordingly a force (horizontal component of the force F in the figure)) is generated, as the shaping stage 112 rises, that acts horizontally on the second particles 50. A frictional force f generated as a result between the second particles 50 and the side wall 111 is large, and takes on an orientation opposite to the direction of ascent of the shaping stage 112. The frictional force f acts so as to hamper ascent of the shaping stage 112, and thus rising of the shaping stage 112 may become unstable.

As illustrated in FIG. 11B, in a case where by contrast the relationship between the distance d of the gap 115 and the particle size R2 of the second particles 50 satisfies Expression (7) above, no horizontal-direction force is generated in the second particles 50 when the shaping stage 112 rises. Accordingly, a frictional force f generated between the second particles 50 and the side wall 111 is small. In consequence the shaping stage 112 can rise more stably in the case of FIG. 11B (Condition 3) than in the case of FIG. 11A (Condition 2).

First Sintering Step

The stack including the non-shaping portion N and obtained in the above shaped object creation step is thermally treated under conditions of 650° C. for 1 hour. The atmosphere in the heating treatment is a nitrogen atmosphere, and the oxygen partial pressure during sintering is adjusted to 10⁻⁴ atm O₂.

Retrieval Step

After the first sintering step, the non-shaping portion N is removed from the stack by air blowing, to yield a shaped object A.

Second Sintering Step

The shaped object A obtained in the above-mentioned retrieval step was sintered in an electric furnace in a nitrogen atmosphere, under conditions of oxygen concentration of 10⁻⁸ atm O₂, at 1300° C. for 1 hour, to yield a final shaped object.

The first particles 20 can be caused to be sintered to one another as a result of the second sintering step, and hence the density of the first particles 20 in the shaped object A that is obtained in the first sintering step can be further increased as a result. The heating temperature (T2) in the second sintering step is set to a temperature higher than the heating temperature (T1) in the first sintering step.

In the art disclosed herein, thus, the second particles 50 of larger particle size than the shortest distance between the side wall 111 of the shaping container 110 and the shaping stage 112 are interposed between the shaping stage 112 and the powder layer 201 formed by the first particles 20. As a result, it becomes possible to prevent the first particles 20 from intruding into the gap 115 between the edge 112a of the shaping stage 112 and the side wall 111 of the shaping container 110, and to prevent the first particles 20 from flowing out of the shaping container 110 through the gap 115, at the time of raising/lowering of the shaping stage 112. In the above embodiment a sintering step is carried out once shaping is over, but in the art disclosed herein for instance a stack heating step by laser may be adopted as the sintering method, instead of the above sintering step. In this case, fusion or combustion of the second particles 50 is induced, at the time of heating, when a material of low heat resistance such as a rubber or resin is used as the second particles 50, and as a result the first particles 20 may flow out of the shaping container 110 through the gap 115. In such a heating step as well, therefore, a ceramic of higher heat resistance than that of rubbers or resins is used as the second particles 50, similarly to the above embodiment, so that the shaping stage can be raised/lowered stably.

An embodiment has been explained above in which nanoparticles are applied in the first powder, and are heated at a temperature at which the nanoparticles sinter or fuse with each other, as a result of which the first particles included in the first powder become connected and fixed to one another via the nanoparticles. However, the present invention is not limited thereto. For instance, the present invention can be suitably used also in a shaping method wherein shaping is performed while fixing the first particles to one another by way of a resin binder that contains no nanoparticles, followed by degreasing of the resin binder, and fixing of the first particles to one another.

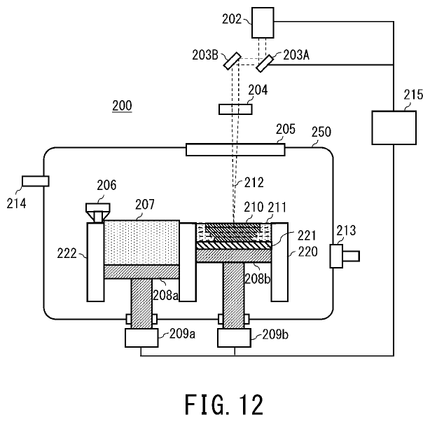

Likewise, the present invention can be suitably used in a powder bed fusion method in which an energy beam is projected onto a powder layer according to slice data of a three-dimensional model, and the powder layer is solidified while being melted and congealed. FIG. 12 illustrates an outline of a device used in a powder bed fusion method.

The shaping device 200 has a chamber 250 such that the atmosphere in the interior thereof can be controlled by a gas introduction mechanism 213 and by an exhaust mechanism 214. The shaping device 200 has, in the interior of the chamber 250, a shaping container 220 for shaping a three-dimensional object, and a powder container 222 that accommodates a starting material powder (hereafter also referred to as shaping material or powder, for short) which is a shaping material. Further, the shaping device 200 has a powder layer formation mechanism 206 for spreading the starting material powder 207 accommodated in the powder container 222 onto the shaping container 220, to a predetermined thickness. In the present invention a starting material powder 207 of a predetermined thickness will be referred to as powder layer 211.

The exhaust mechanism 214 may be applied with a pressure adjustment mechanism, such as a butterfly valve, for the purpose of pressure adjustment, or may have a configuration (generally referred to as blow replacement) in which the atmosphere within the chamber is adjusted through supply of a gas and the accompanying rise in pressure.

The vertical-direction positions of the bottom parts 208a, 208b of the shaping container 220 and of the powder container 222 can be modified by respective raising/lowering mechanisms. The bottom part 208b of the shaping container 220 is configured in the form of a stage to which a base plate 221 is detachably fixed. The direction and amount of movement of the raising/lowering mechanisms are controlled by a control unit 215, such that the amount of movement of the bottom of the powder container 222, i.e. the stage 208, is established in accordance with the thickness of the powder layer 211 that is formed. Ordinarily, the height resolution of the raising/lowering mechanisms is preferably set to be 1 μm or less, in order to cause each stage 208 to move vertically by a height of several tens of μm.

The base plate 221 is a plate made up of a material that can be melted by an energy beam. The surface of the base plate 221 is melted together with the shaping material at the time of melting and solidification of the first powder layer, as a result of which the shaped object can be fixed to the base plate 221. In consequence, the shaped object can be held during shaping so that the position of the shaped object on the base plate 221 does not shift, and high-precision shaping can be realized. Once shaping is complete, the base plate 221 is mechanically separated from the shaped object.

The powder layer formation mechanism 206 supplies starting material powder accommodated in the powder container 222 to the shaping container 220, and has a squeegee and/or a roller for evening out the thickness to which the powder layer is set on the base plate 221. In order to increase the density of the obtained shaped object and promote chemical reactions in the powder, preferably the powder layer formation mechanism 206 is provided with both a squeegee and a roller, such that the thickness of the powder layer is adjusted by the squeegee after which the density of the powder layer is increased through pressing by the roller.

The shaping device 200 further has an energy beam source 202 for fusing the starting material powder, scanning mirrors 203A, 203B for scanning with an energy beam 212 in two axes, and an optical system 204 for condensing an energy beam onto the irradiated portion. The energy beam 212 is projected from outside a chamber 250, and accordingly the chamber 250 has provided therein an introduction window 205 for introducing the energy beam 212 into the interior of the chamber. The power density and scanning position of the energy beam are controlled by the control unit 215 in accordance with the three-dimensional shape data of the object to be shaped and the characteristics of the shaping material, acquired by the control unit 215. The position of the shaping container 220 and the optical system 204 are adjusted beforehand so as to achieve a desired beam diameter on the surface of the powder layer 211. The beam diameter on the surface of the powder layer 211 is preferably set to 30 to 100 μm, owing to the influence of the beam diameter on shaping precision.

Galvano mirrors can be suitably used as the scanning mirrors 203A and 203B. Galvano mirrors operate at high speed while reflecting energy beams, and accordingly are preferably made up of a material that is lightweight had has a low coefficient of linear expansion.

Lasers are widely used as the energy beam 212. Habitually YAG lasers are used herein, but also a CO₂ laser or semiconductor laser may be used. The driving scheme involved may be a pulse scheme or a continuous irradiation scheme. Preferably, the laser is selected in accordance with the absorption wavelength of the powder, and the laser may be of a wavelength at which absorption by the powder is 50% or higher, more preferably of a wavelength in which absorption is 80% or higher.

Methods for controlling the irradiation intensity of the laser include a method for controlling in-plane laser power density and a method for controlling spatial laser power density. The in-plane laser power density is laser irradiation intensity per unit area, and is expressed in units of J/mm². The spatial laser power density is laser irradiation intensity per unit volume, and is expressed as J/mm³. In a case where the shaped object is formed through control of layer thickness, as in a 3D printer, it is warranted to take spatial laser power density into consideration. The spatial laser power density J is given by Expression (8) below:

J=W/(P×V×D) (8).

In the expression, W is the irradiation power of the laser, P is the irradiation pitch of the laser, V is the scanning speed of the laser and D is powder spread thickness. The laser power W is ordinarily 10 to 1000 W, the irradiation pitch P of the laser is ordinarily 5 to 500 μm, the laser scanning speed is ordinarily 10 to 10000 mm/sec, and the powder spread thickness D is ordinarily 5 to 500 μm. The parameters W, P, V and D may be controlled to lie within the above ranges, and J may be set to lie in the range of 10 to 1000 J/mm³. The lower limit of 10 J/mm³ is herein the energy necessary for sufficiently fusing the powder, and the upper limit of 1000 J/mm³ is that of a region in which shaping is not possible on account of volatilization of the powder.

At the time of shaping, the base plate 221 is fixed to the stage 208, after which second particles 240 are disposed along the gap between the shaping container and the stage 208, and thereafter the interior of the chamber 101 is replaced with an inert gas such as nitrogen or argon. First particles 230 are spread subsequently at the slice pitch of slice data generated from the three-dimensional shape data of the object to be shaped, i.e. to a thickness corresponding to stack pitch, to form the powder layer 211.

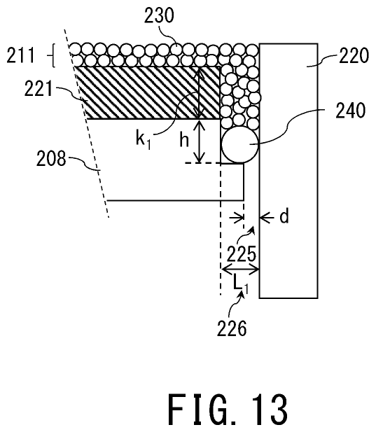

FIG. 13 illustrates an enlargement of an example of a gap portion between the stage 208 and the shaping container 220. In the example of FIG. 13 there is used a stage 208 the size whereof in the thickness direction is modified to exhibit two tiers, such that in the structure of the stage 208 the size of the surface on which the base plate 221 is fixed is smaller than the size on the reverse side thereof. A relationship between d, L₁ and R2, satisfies Expression (9) below where d is the width of a gap 225 between the lower edge of the stage 208 and the side wall of the shaping container 220, L₁ is the width of a gap 226 between the edge of the top (side on which the base plate 221 is disposed) of the stage 208 and the shaping container 220, and R2 is the particle size of the second particles 240.

d<R2<L₁ (9)

Therefore, the second particles 240 disposed along the gap between the shaping container and the stage 208 intrude into the gap 226 between the edge of the top of the stage 208 and the shaping container 220, so that the first particles 230 can be prevented as a result from getting into the gap.

Further, h, k₁ and R2 satisfy Expression (10) below, where h is the height of the small-size portion on the side where the base plate 221 is disposed, and k₁ is the thickness of the base plate 221.

R2<h+k₁ (10)

In the drawings there holds R2<h, but this is not limiting, and it suffices herein that the total of h plus k₁ be smaller than R2. By satisfying such a relationship, it becomes possible to melt and solidify the first powder layer normally, without interference by the second particles 240, at the time of formation of powder layers made up of the first particles 230 on the surface of the base plate 221.

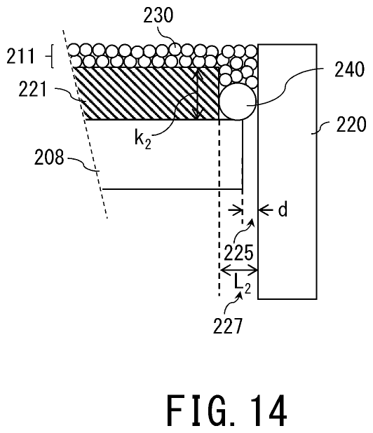

FIG. 14 illustrates an enlargement of another example of the gap portion between the stage 208 and the shaping container 220. In the example of FIG. 14, similarly to the example in FIG. 8, the size of the stage 208 in the thickness direction is constant, and the width of the gap 225 between the edge of the stage 208 and the side wall of the shaping container 220 is d, but the size of the base plate 221 is smaller than that of stage 208. Herein d is the width of the gap 225 between the edge of the stage 208 and the shaping container 220, L₂ is the width of a gap 227 between the edge of the base plate 221 and the shaping container 220, when the stage 208 is fixed to the base plate 221. Defining R2 as the particle size of the second particles 240, then d, L₂ and R2 satisfy Expression (11) below:

d<R2<L₂ (11).

By satisfying such a relationship, the second particles 240 disposed along the gap between the shaping container and the stage 208 can intrude into the gap 227 between the edge of the stage 208 and the shaping container 220, and the first particles 230 can be prevented from getting into the gap.

Further, the thickness k₂ of the base plate 221 and R2 satisfy Expression (12) below:

R2<k₂ (12).

By satisfying such a relationship, it becomes possible to melt and solidify the first powder layer normally, without interference by the second particles 240, at the time of formation of powder layers made up of the first particles 230 on the surface of the base plate 221.

In FIGS. 13 and 14, widths L₁ and L₂ are distances such that only single second particles 240 are immobilized, but a design may be adopted in which a plurality of second particles 240 is immobilized, so long as the first particles 230 can be prevented from spilling down through the gap 225. In this case there may be adjusted L₁, h and k₁, or L₂ or k₂.

The powder layer 211 formed on the base plate 221 is scanned with the energy beam 212, in accordance with slice data, and a laser beam is projected onto the powder in a predetermined region.

Once laser projection for one layer based on the slice data is over, the shaping stage 208b is lowered by one stack pitch, and the bottom part 208a of the material container 222 is raised, in accordance with the stack pitch, by the raising/lowering mechanisms. The starting material powder of the material container 222 is caused to move to the shaping container 220 by the powder layer formation mechanism 206, and the powder is spread on the layer scanned with the energy beam, to form a new powder layer 211, which is then scanned and irradiated with the energy beam 212.

Also the surface of the layer having been scanned earlier with the energy beam 212, as described above, is solidified again in the region irradiated with the energy beam 212. In a case where in the new powder layer there is an already solidified region directly below the region irradiated with the energy beam 212, then the material of the beam irradiation region of the new powder layer mixes with that of the former, with solidification and mutual bonding, at a boundary between the beam irradiation region of the new powder layer and the region having already melted and solidified.

The shaped object 210 can be formed by repeating the above operations.

Also in the device of FIG. 12, similarly to the device in FIG. 5, the average particle size R1 of the first particles 20, the particle size R2 of the second particles 50, and the distance d of the gap between the edge of the shaping stage 112 and the side wall of the shaping container 220 preferably satisfy Expression (13) below:

R1≤d≤R2/2 (13).

The present invention suppresses outflow of a shaping material from between a shaping container and a shaping stage, at the time of shaping of a shaped object, but no limitation whatsoever is imposed on the method for fixing the first particles to one another.

The art disclosed herein allows effectively preventing outflow of a shaping material from between a shaping container and a shaping stage at the time of shaping of a shaped object.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-108194, filed on Jun. 10, 2019 and the benefit of Japanese Patent Application No. 2020-89385, filed on May 22, 2020, which are hereby incorporated by reference herein in their entirety.

What is claimed is:

1. A three-dimensional shaping method for forming a shaped object using a powder made up of first particles, on a vertically movable shaping stage within a shaping container, the method comprising a step of:
forming a powder layer made up of the first particles, on the shaping stage on which second particles that have a larger particle size than a particle size of each of the first particles are disposed along a gap between the shaping container and the shaping stage,
wherein R1 being an average particle size of the first particles, R2 being an average particle size of the second particles and d being a distance of the gap between the shaping container and the shaping stage, satisfy Expression (1) below:
R1≤d<R2 (1).

2. The three-dimensional shaping method of claim 1, wherein R1, R2 and d further satisfy Expression (2) below:
R1≤d≤R2/2 (2).

3. The three-dimensional shaping method of claim 2,
further comprising forming the shaped object within the powder layer by a liquid that binds the powder layer,
wherein the liquid contains nanoparticles having an average particle size of R3, and
Expression (3) below is satisfied:
R3<R1 (3).

4. The three-dimensional shaping method of claim 3, wherein after the liquid is applied to the powder layer, the powder layer is heated at a temperature equal to or higher than a sintering temperature, or equal to or higher than a melting point of the nanoparticles, and lower than a melting point of the first particles and lower than the melting point of the second particles.

5. The three-dimensional shaping method of claim 3, wherein a solvent of the liquid is water.

6. The three-dimensional shaping method of claim 3, wherein the liquid is applied to the powder layer by an inkjet system.

7. The three-dimensional shaping method of claim 1, wherein the first particles are made up of a ceramic.

8. The three-dimensional shaping method of claim 7, wherein the first particles are made up of a metal, or of a ceramic different from a ceramic of the second particles.

9. The three-dimensional shaping method of claim 2, further comprising a step of irradiating the powder layer with an energy beam in accordance with slice data of a three-dimensional model, and solidifying the powder layer.
